(19) United States
(12) Patent Application Publication
(10) Pub. No.: US 2016/0122215 A1
(43) Pub. Date: May 5, 2016

(54) REACTOR SETUP

(71) Applicant: Liquid Waste Treatment Systems Limited, Napier (NZ)

(72) Inventors: Zhiguo Yuan, Middle Park (AU); Maria Teresa Pijuan Vilalta, Ivars D'urgell Lleida (ES); Michael Russel Johns, Aspley (AU); Susan Diane McDougald, Glebe (AU)

(73) Assignee: Liquid Waste Treatment Systems Limited, Napier (NZ)

(21) Appl. No.: 14/870,953

(22) Filed: Sep. 30, 2015

Related U.S. Application Data
(63) Continuation of application No. 13/582,360, filed on Dec. 7, 2012, now abandoned.

(30) Foreign Application Priority Data
Mar. 3, 2010 (AU) 20109000901

(51) Int. Cl. C02F 3/12; C02F 3/34; C02F 3/30

(52) U.S. Cl. CPC C02F 3/1205; C02F 3/121; C02F 3/301; C02F 3/34; C02F 2303/26

(57) ABSTRACT

The present invention provides a process for reducing the start-up time of an aerobic granular sludge reactor, said process comprising starting said reactor with an active biomass comprising fragmented aerobic sludge granules.

### FIELD OF THE INVENTION

The present invention relates to processes for reducing the start up time for aerobic granular sludge reactors, and finds application especially in the field of biological processes for at least partial removal of nitrogen and COD/BOD, and optionally phosphorus from wastewaters.

### BACKGROUND TO THE INVENTION

In recent years, aerobic granular sludge has become a promising technology for wastewater treatment. It presents several advantages compared to conventional floccular sludge systems including lower operational costs and lower space requirement. Aerobic granules are aggregates of microbial origin which do not coagulate under reduced hydrodynamic shear and which subsequently settle significantly faster than activated sludge flocs.

However, one of the major drawbacks of this technology is the long start-up time required for these reactors when dealing with real wastewaters and when nutrient removal is necessary.

Several industry sectors such as the dairy and food processing industries and abattoirs are producers of large volumes of wastewater requiring treatment and containing high levels of nitrogen, as well as COD and phosphorous. Such wastewaters have been found to present difficulties in establishing wastewater treatment reactors comprising aerobic granules.

Thus, an objective of the present invention is to provide improved processes for more readily establishing aerobic granular sludge reactors.

### SUMMARY OF THE INVENTION

Through the present studies, it has surprisingly been found that aerobic sludge granules can be fragmented and the fragments used to establish aerobic granular sludge reactors with significantly reduced start-up times compared to establishing such reactors from active biomass comprising floccular sludge only. Thus, according to an embodiment of the invention, there is provided a process for establishing an aerobic granular sludge reactor, said process comprising seeding said reactor with an active biomass comprising fragmented aerobic sludge granules.

The optimum size of the fragmented granules for any particular reactor may be established by trial and error. According to an embodiment, said reactor is seeded with fragmented aerobic sludge granules having a median particle size of from about 150 μm to about 1250 μm, such as from about 500 to about 700 μM.

While the reactor may conceivably be started using fragmented sludge granules only, according to a preferred embodiment the reactor is seeded with an active biomass comprising a mixture of fragmented aerobic sludge granules and floccular sludge.

According to an embodiment the fragmented aerobic sludge granules comprise from about 5% to about 50% of the total seeding active biomass by weight.

According to another embodiment, the initial concentration of active biomass in the reactor is from about 1 gMLSS/L to about 5 gMLSS/L, such as from about 2.5 gMLSS/L to about 3.5 gMLSS/L.

According to another embodiment, the aerobic granular sludge reactor is initially run with a wastewater loading providing a volumetric exchange ratio per cycle of from about 12.5% to about 25%. Eventually, as the aerobic granular sludge is more established, a wastewater loading providing a volumetric exchange ratio per cycle of up to about 50% with a nutrient-rich wastewater, or even up to 75% with a wastewater low in nutrients (such as domestic wastewater) may be employed.

According to another embodiment, the settling time between completion of a treatment cycle and decanting of the treated liquor is gradually reduced over the number of treatment cycles run during establishment of the reactor, to remove poorly settling biomass from the reactor.

According to another embodiment, the active biomass comprises nitrifying and denitrifying organisms and said reactor is for removal of biological COD and nitrogen from wastewater.

According to another embodiment, nitrogen removal from the wastewater occurs predominantly through nitritation/denitritation.

According to another embodiment, the active biomass comprises polyphosphate accumulating organisms (PAOs) and said reactor is for simultaneous removal of nitrogen, phosphate and biological COD from wastewater.

Processes according to the present invention may be used to set up aerobic granulated sludge reactors for carrying out processes for simultaneous removal of BOD, N and P from wastewaters as described in international patent publication No. WO 2008/046139 titled “Wastewater Treatment”, the entirety of which is incorporated herein by cross-reference.

The present invention also provides fragmented aerobic sludge granules having a particle size of from about 150 μm to about 1250 μm, optionally stored in medium or treated wastewater comprising low nutrient levels.

### BRIEF DESCRIPTION OF THE DRAWINGS

FIG. 1 shows a schematic diagram of a sequencing batch reactor for use in a process according to the invention.

FIGS. 2A to 2D show granule size distribution profiles (A and B) and MLSS & MLVSS (C and D) of SBRs seeded with 100% floccular sludge: A, C—1^{st} round; B, D—2^{nd} round. Percentiles: ▾ d(0.9), ∘ d(0.5), • d(0.1); □ MLVSS, ▪ MLSS.

FIGS. 3A and 38 shows nitrogen removal performance of SBRs seeded with 100% floccular sludge: A—1^{st} round; B—2^{nd} round. • N—NH₄⁺ influent, ∘ N—NH₄⁺ effluent, ▾ N—NOx,—volumetric exchange ratio.

FIGS. 4 A to E show granule size distribution profiles in SBRs over almost 90 days or more of wastewater treatment cycles after initial seeding with different percentages of fragmented granules: A—50%; B—25%; C—15%; D—10%; E—5%. Percentiles: ▾ d(0.9), ∘ d(0.5), • d(0.1).

FIGS. 5A and 5B show stereomicroscope images of the morphology of sludge from the beginning (FIG. 5A) and the last week of operation (FIG. 5B) from an SBR seeded with 10% fragmented granules.

FIG. 6 shows the effect of the percentage of fragmented granules in seeding sludge on the time required for a reactor to become fully granulated when treating abattoir wastewater.

FIGS. 7 A to E show MLSS and MLVSS in SBRs over almost 90 days or more of wastewater treatment cycles after initial seeding with different percentages of fragmented granules: A—50%; B—25%; C—15%; D—10%; E—5%. ∘ MLVSS, • MLSS.

FIGS. 8 A to E show nitrogen removal performance of SBRs over almost 90 days or more of wastewater treatment cycles after initial seeding with different percentages of fragmented granules: A—50%; B—25%; C—15%; D—10%; E—5%. • N—NH₄⁺ influent, ∘ N—NH₄⁺+N—NOx,—exchange ratio.

FIG. 9 shows cycle study profiles obtained on day 14, 32, 40 and 116 in an SBR seeded with 15% fragmented granules: • P—PO₄³⁻; ∘ N—NH₄⁺; ▾ N—NO₂⁻; Δ N—NO₃⁻.

FIGS. 10 A to E show phosphorous removal performance of SBRs over almost 90 days or more of wastewater treatment cycles after initial seeding with different percentages of fragmented granules: A—50%; B—25%; C—15%; D—10%; E—5%. • P—PO₄³⁻ influent, ∘ P—PO₄³,—volumetric exchange ratio.

FIGS. 11A and 11B shows stereomicroscope images of the morphology of the sludge from the 1^{st} day of reactor operation: A: b-SBR; B: m-SBR. (Scale-bar represents 1 mm).

FIGS. 12A and 12B show granule size distribution profiles in SBRs (after mixing of granules with floccular sludge) over more than 100 days of wastewater treatment cycles after initial seeding with 30% fragmented granules. A: b-SBR; B: m-SBR. Volumetric percentiles: ▾ d(90%), ∘ d(50%), • d(10%)

FIGS. 13A and 1313 show stereomicroscope images of the morphology of the sludge on day 92 of operation. A: b-SBR; B: m-SBR.

### ABBREVIATIONS AND DEFINITIONS

The following abbreviations are used herein:

AOB ammonia oxidising bacteria

BOD biochemical oxygen demand

COD chemical oxygen demand

DO dissolved oxygen

EBPR enhanced biological phosphorous removal

FOG fat, oil and grease

GAO glycogen accumulating organism

HRT hydraulic residence time

MLSS mixed liquor suspended solids

MLVSS mixed liquor volatile suspended solids

N nitrogen

NH₄ ammonium

NO₂ nitrite

NO₃ nitrate

NOₓ sum of nitrate and nitrite

NOB nitrite oxidising bacteria

OUR oxygen uptake rate

P phosphorous

PO₄ phosphate

PAO polyphosphate accumulating organism

PHA polyhydroxyalkanoate

SBR sequencing batch reactor

SRT sludge retention time

TKN total Kjeldahl nitrogen

TP total phosphorous

TSS total suspended solids

VER volumetric exchange ratio

VFA volatile fatty acid

VSS volatile suspended solids

As used herein, the term “comprising” means “including principally, but not necessarily solely”. Variations of the word “comprising”, such as “comprise” and “comprises”, have correspondingly similar meanings.

As used herein, the term “polyphosphate accumulating organism” means any organism capable of taking up phosphorus in excess of its metabolic requirements and accumulating it intracellularly as a phosphate rich species.

### DETAILED DESCRIPTION OF THE INVENTION

Aerobic granular sludge provides significant advantages compared to known floccular systems, including reduced settling times, improved biomass retention in the bioreactors (providing the joint benefits of the possibility of greater wastewater loading per cycle, and a reduced amount of sludge decanted from reactors after each water treatment cycle, thereby requiring reduced secondary settlement provisions), and providing aerobic and anoxic conditions on/in the granules, thereby promoting different biological processes within the one reactor (such as nitrogen removal through the nitrite pathway, which in turn introduces savings in aeration and supplemented carbon).

However, establishing aerobic granular sludge reactors can be a lengthy and delicate process. In particular, an aerobic granular sludge is developed by promoting retention of such granules in a reactor by reducing settling times before decanting supernatants and by increasing volumetric exchange ratios/decreasing hydraulic retention times as well. Accordingly, a majority of the biomass may be washed out during establishment. This in turn may leave insufficient biomass in the reactor to remove nitrogenous materials in the wastewater being treated. Accumulation of ammonium and/or nitrous acid in the reactor can then inhibit the functionality of the microorganisms responsible for oxidation of NH₄⁺ to NOx and removal of NOₓ compounds and phosphorous.

The present invention hereby provides improved processes for starting up aerobic granular sludge reactors, comprising using fragmented established aerobic granules as seeding active biomass for starting such reactors. Surprisingly, fragmented aerobic granules substantially retain their aerobic granule functionality, and re-develop into fully functional aerobic granules relatively quickly, and much quicker than establishing an aerobic granule sludge reactor starting with floccular sludge only.

Granules for Fragmentation and Use in Processes of the Present Invention May be Obtained from any Suitable Source

The granules may, be fragmented by any suitable means. Aerobic granules are complex, having structure (including surfaces of varying shapes, some with outgrowths, others without, and including pores, channels and voids) and a gradient of microbiological types from the surface to the centre, corresponding with oxygen availability and mass transfer of substrate (amongst other parameters) which are maximal at the surface of each granule and decrease quickly with distance into the centre (which, in mature/aged granules may comprise mostly dead cells). Efficient functioning of the granules is influenced, at least in part, on the structure of the granules and the consequential environment. However, the present studies have found that some disruption, through fragmentation, can be tolerated, with the fragmented granules recovering (presumably through restructuring, without wishing to be bound to any particular theory). Thus, according to an embodiment, the granules are fragmented by means which retain at least some of the structure, and therefore functionality of the granules.

A number of industrial mills, comminutors, fragmenters, screening or seiving machinery may be suitable, such as the gentle milling/seiving machinery (Fitzmill® and Fitzseive® products) available from Fitzpatrick Company of Elmhurst, Ill., United States of America or similar products available from, for example, Franklin Miller, Inc. of New Jersey, United States of America. According to an embodiment, the granules are passed through a mesh, sieve or screen to create fragmented granules. According to a further embodiment, the mean pore diameter or hole size/width of said mesh, sieve or screen is from about 200 μm to about 1000 μm (from about US 70 mesh to about 18 mesh), such as from about 300 μm to about 1000 μm (from about US 50 mesh to about 18 mesh), from about 400 μm to about 1000 μm (from about US 40 mesh to about 18 mesh), from about 500 μm to about 1000 μm (from about US 35 mesh to about 18 mesh), from about 600 μm to about 1000 μm (from about US 30 mesh to about 18 mesh), from about 700 μm to about 1000 μm (from about US 25 mesh to about 18 mesh), from about 800 μm to about 1000 μm (from about US 20 mesh to about 18 mesh), from about 900 μm to about 1000 μm (from about US 20 mesh to about 18 mesh), from about 200 μm to about 900 μm (from about US 70 mesh to about 20 mesh), from about 200 μm to about 800 μm (from about US 70 mesh to about 20 mesh), from about 200 μm to about 700 μm (from about US 70 mesh to about 25 mesh), from about 200 μm to about 600 μm (from about US 70 mesh to about 30 mesh), from about 200 μm to about 500 μm (from about US 70 mesh to about 35 mesh), from about 200 μm to about 400 μm (from about US 70 mesh to about 40 mesh), from about 200 μm to about 300 μm (from about US 70 mesh to about, 50 mesh), from about 300 μm to about 900 μm (from about US 50 mesh to about 20 mesh), from about 350 μm to about 800 μm (from about US 45 mesh to about 20 mesh), from about 400 μm to about 700 μm (from about US 40 mesh to about 25 mesh), from about 450 μm to about 650 μm (from about US 0.40 mesh to about 25 mesh), from about 500 μm to about 700 μm (from about US 35 mesh to about 25 mesh), from about 500 μm to about 600 μm (from about US 35 mesh to about 40 mesh), about 200 μm (about US 70 mesh), about 300 μm (about US 50 mesh), about 400 μm (about US 40 mesh), about 500 μm (about US 35 mesh), about 600 μm (about US 30 mesh), about 700 μm (about US 25 mesh), about 800 μm (about US 20 mesh), about 900 μm (about US 20 mesh), about 1000 μm (about US 18 mesh), or any, or any range comprising any combination of any of the above listed size limits.

The fragmented granules resulting from fragmentation may have a median particle size/diameter of from about 150 μm to about 1250 μm, such as from about 200 μm to about 1100 μm, from about 200 μm to about 1000 μm, such as from about 300 μm to about 1000 μm, from about 400 μm to about 1000 μm, from about 500 μm to about 1000 μm, from about 600 μm to about 1000 μm, from about 700 μm to about 1000 μm, from about 800 μm to about 1000 μm, from about 900 μm to about 1000 μm, from about 200 μm to about 900 μm, from about 200 μm to about 800 μm, from about 200 μm to about 700 μm, from about 200 μm to about, 600 μm, from about 200 μm to about 500 μm, from about 200 μm to about 400 μm, from about 200 μm to about 300 μm, from about 300 μm to about 900 μm, from about 350 μm to about 800 μm, from about 400 μm to about 700 μm, from about 450 μm to about 650 μm, from about 500 μm to about 700 μm, from about 500 μm to about 600 μm, about 150 μm, about 200 μm, about 300 μm, about 400 μm, about 500 μm, about 600 μm, about 700 μm, about 800 μm, about 900 μm, about 1000 μm, about 1100 μm, about 1250 μm, or any, or any range comprising any combination of any of the above listed size limits. According to an embodiment, the median size of the fragmented granules is from about 400 μm to about 800 μm. According to an embodiment, the median size of the fragmented granules is from about 500 μm to about 700 μm.

The fragmented granules are reasonably stable, and may be stored in the presence of low nutrient levels for days to even weeks, especially if refrigerated. This allows for fragmentation of the granules at the facility where they are produced and then carting to other facilities (conveniently after dewatering). Alternatively, the intact granules may be transported to the intended facility and the granules fragmented at that location before loading into a reactor.

A process of the present invention for starting up an aerobic granular sludge reactor, comprises loading a reactor with fragmented granules. The reactor may also be loaded with floccular sludge. According to an embodiment, the fragmented aerobic granules comprise from about 5% to about 50% of the total active biomass by weight, such as from about 5% to about 45%, from about 5% to about 40%, from about 5% to about 35%, from about 5% to about 30%, from about 5% to about 25%, from about 5% to about 20%, from about 5% to about 15%, from about 5% to about 10%, from about 10% to about 50%, from about 15% to about 50%, from about 20% to about 50%, from about 25% to about 50%, from about 30% to about 50%, from about 35% to about 50%, from about 40% to about 50%, from about 45% to about 50%, about 5%, about 10%; about 15%, about 20%, about 25%, about 30%, about 35%, about 40%, about 45%, about 50%, or any, or any range comprising any combination of any of the above listed percentage limits. According to an embodiment, a reactor may be started up with active biomass comprising from about 10% to about 25% fragmented aerobic granules.

The total amount of active biomass loaded into the reactor at start up, as fragmented aerobic granules, optionally in combination with floccular sludge, may be from about 0.5 g dry weight MLSS per litre final total working volume to about 20 g dry weight MLSS per litre final total working volume, such as from about 0.5 g/L to about 18 g/L, from about 0.5 g/L to about 16 g/L, from about 0.5 g/L to about 14 g/L, from about 0.5 g/L to about 12 g/L, from about 0.5 g/L to about 10 g/L, from about 0.5 g/L to about 9 g/L, from about 0.5 g/L to about 8 g/L, from about 0.5 g/L to about 7 g/L, from about 0.5 g/L to about 6 g/L, from about 0.5 g/L to about 5 g/L, from about 0.5 g/L to about 4 g/L, from about 0.5 g/L to about 3 g/L, from about 0.5 g/L to about 2 g/L, from about 0.5 g/L to about 1 g/L, from about 1 g/L to about 20 g/L, from about 2 g/L to about 20 g/L, from about 3 g/L to about 20 g/L, from about 4 g/L to about 20 g/L, from about 5 g/L to about 20 g/L, from about 6 g/L to about 20 g/L, from about 7 g/L to about 20 g/L, from about 8 g/L to about 20 g/L, from about 9 g/L to about 20 g/L, from about 10 g/L to about 20 g/L, from about 12 g/L to about 20 g/L, from about 14 g/L to about 20 g/L, from about 16 g/L to about 20 g/L, from about 18 g/L to about 20 g/L, about 0.5 g/L, about 1 g/L, about 2 g/L, about 3 g/L, about 4 g/L, about 5 g/L, about 6 g/L, about 7 g/L, about 8 g/L, about 9 g/L, about 10 g/L, about 11 g/L, about 12 g/L, about 13 g/L, about 14 g/L, about 15 g/L, about 16 g/L, about 17 g/L, about 18 g/L, about 19 g/L, about 20 g/L, or any, or any range comprising any combination of any of the above listed amounts. According to an embodiment, the initial concentration of active biomass in the reactor is from about 1 gMLSS/L to about 5 gMLSS/L. According to another embodiment, the initial concentration of active biomass in the reactor is from about 2 gMLSS/L to about 3 gMLSS/L.

The next step in starting a sludge reactor up comprises feeding the active biomass with wastewater, or any appropriate nutrient-containing substrate. According to an embodiment the sludge is fed with wastewater.

Wastewater for treatment during set-up of an aerobic granular sludge reactor by a process of the present invention may be any wastewater comprising nutrients utilizable by the sludge microorganisms. Of particular interest are wastewaters with high levels of nitrogen, such as abattoir wastewaters, although the invention is clearly not so limited. Such wastewaters may contain at least 100 mg/L total nitrogen, such as at least about 150 mg/L total nitrogen, at least about 200 mg/L total nitrogen, at least about 250 mg/L total nitrogen, at least about 275 mg/L total nitrogen, at least about 300 mg/L total nitrogen, at least about 325 mg/L total nitrogen, or even at least about 350 mg/L total nitrogen. The total nitrogen content of the wastewater may be significantly higher than 350 mg/L.

High nitrogen influent materials, such as abattoir wastewaters, may also contain elevated amounts of phosphorous. According to an embodiment, a process of the present invention comprises setting up an aerobic granular sludge reactor for simultaneous removal of nitrogen and phosphorous, as well as COD/BOD from wastewaters. Aerobic granular sludge reactors set up by a process according to the present invention may be used for simultaneous removal of BOD, N and P by processes as described in international patent publication No. WO 2008/046139 titled “Wastewater Treatment”, the entirety of which is incorporated herein by cross-reference. Certain processes as described in WO 2008/046139 may also be suitable as feeding/operating profiles for setting up aerobic granular sludge reactors by processes according to the present invention (once adapted for fragmented granular sludge).

A significant problem associated with using reactor influent material comprising high nitrogen levels is accumulation of ammonia and/or nitrite/nitrous acid in the reactor. High levels of these components can inhibit the very organisms involved in nitrogen and phosphorous removal. Accordingly, although influent material comprising low nitrogen levels (such as less than 100 mg/L total nitrogen) may be fed into an establishing aerobic granular sludge reactor at high volumetric exchange ratios (VERs), use of influent materials with a high nitrogen content, such as abattoir wastewaters may require: reducing the volume of wastewater fed into the SBR system each cycle (and therefore reducing the VER); feeding such influent material into the SBR system in two, three or even more than three feeds; allowing for longer process steps (such as nitrification and/or denitrification); or any combination thereof.

As implied above, the VER used for a given influent material will vary depending on the nitrogen content of that material, and could be anywhere between about 5% and about 75%, such as from about 10% to about 75%, from about 10% to about 70%, from about 10% to about 65%, from about 10% to about 60%, from about 10% to about 55%, from about 10% to about 50%, from about 10% to about 45%, from about 10% to about 40%, from about 10% to about 35%, from about 10% to about 30%, from about 10% to about 25%, from about 10% to about 20%, from about 10% to about 15%, from about 15% to about 75%, from about 20% to about 75%, from about 25% to about 75%, from about 30% to about 75%, from about 35% to about 75%, from about 40% to about 75%, from about 50% to about 75%, from about 55% to about 75%, from about 60% to about 75%, from about 65% to about 75%, from about 70% to about 75%, about 5%, about 10%, about 15%, about 20%, about 25%, about 30%, about 35%, about 40%, about 45%, about 50%, about 55%, about 60%, about 65%, about 70%, about 75% or any range comprising any combination of any of the above listed percentage limits. Where a high nitrogen content influent is used, an aerobic granular sludge reactor may be initially operated with a wastewater loading providing a volumetric exchange ratio of from about 12.5% to about 25% (that is, for example, if the working volume of the reactor is 1 Litre, a total of from about 125 mL to 250 mL wastewater is fed to the reactor during one cycle). To avoid inhibiting the nitrifiers in the establishing granular sludge, the initial VER applied may be low, and gradually increased over subsequent cycles, while monitoring ammonium and NOₓ species, to ensure that these do not rise to inhibiting levels. As a guide only: for ammonia oxidizing bacteria, a concentration of from about 10 mg to about 15 mg nitrogen/L of free ammonia or a concentration of from about 0.2 mg to about 2.8 mg nitrogen/L free nitrous acid may cause full inhibition of their activity; for nitrite oxidizing bacteria a concentration of from about 0.016 mg to about 0.048 mg nitrogen/L free nitrous acid stops growth; and for polyphosphate accumulating organisms (PAOs), concentration of about 0.004 mg nitrogen/L free nitrous acid stops phosphorous uptake.

The concentration of NO species in the reaction vessel contents may be monitored by monitoring the oxidation/reduction potential (ORP) and/or pH of the reaction vessel contents, by using an online NOₓ sensor, or any combination thereof.

As the aerobic sludge reactor establishes towards a fully granulated state, the capacity for the active biomass in the reactor to remove nitrogenous material from the influent will increase, and the VER applied can be increased. Thus, for example, as an aerobic granular sludge is more established, a wastewater loading providing a volumetric exchange ratio of up to about 50% for high nitrogen content influent material, such as abattoir wastewater may be employed.

It has also previously been found that a step-feed SBR scheme, characterised by alternating aerobic and anoxic phases in a SBR cycle allows timely removal of nitrate or nitrite so that, when an adequate amount of COD is available, ammonia, nitrate and nitrite build-up can be avoided.

At least a first feed step may be followed by a non-aerated period of sufficient duration to result in sufficiently low concentrations of NOₓ species in the wastewater to allow for accumulation of polyhydroxyalkanoates in the PAOs, thereby allowing for phosphate accumulation by PAOs in a subsequent aerated/aerobic period.

At least the first non-aerated period is followed by an aerated period of sufficient duration to allow for ammonium oxidation by the nitrifying organisms and assimilation by the PAOs of at least a portion of the phosphorous in the wastewater. Depending on the quality of effluent desired from the process, at least the first aerated period may be of sufficient duration so as to allow for substantially complete oxidation of ammonium introduced into the SBR system by the feed step. Subsequent aerated periods may also be of sufficient duration to allow for substantially complete ammonium oxidation by the nitrifying organisms after each feeding step.

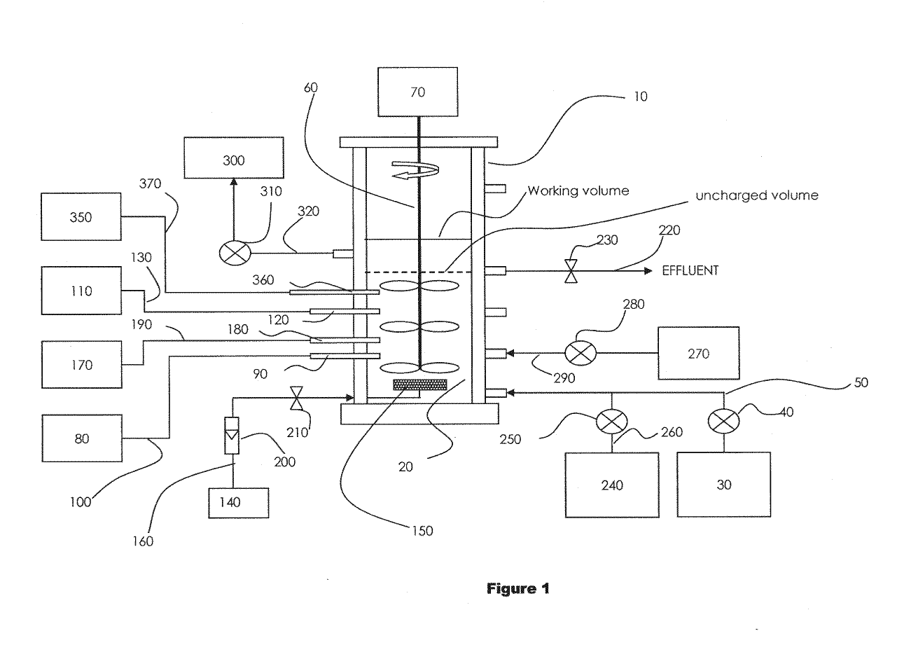

Referring to FIG. 1, an embodiment of a process according to the invention may be carried out in a sequencing batch reactor system comprising a reaction vessel 10 containing a biologically active sludge 20 comprising from about 10% to 25% (w/w) fragmented granules and from about 90% to about 75% (w/w) floccular sludge, wherein both the granules used for preparation of the fragmented granules, and the floccular sludge have been obtained from reactors providing simultaneous N, P and COD removal from abattoir wastewaters, and wherein the median fragmented granule diameter/size is from about 400 to about 800 μm.

In a first feeding step, a portion of wastewater to be treated is fed into reaction vessel 10 from wastewater reservoir 30 by pump 40 via conduit 50. If multiple feeding steps are to be carried out, although the amounts of wastewater fed at each stage may be the same, they may also be of increasingly smaller volume, increasingly larger volume, alternating larger and smaller volumes, or any permutation thereof. However, a large final feed step may result in significant ammonia and NOₓ levels in the reactor and in the discharge, and therefore, according to an embodiment, feed steps of progressively smaller size are employed.

In a specific embodiment, where wastewater carrying high levels of nutrients, such as abbatoir wastewater, is treated, about 70% of the wastewater to be treated may be fed into the reaction vessel in a first feed step, and about 30% in a second feed step. Alternatively, about 60% of the wastewater to be treated may be fed into the reaction vessel in a first feed step, and about 40% in a second feed step. Yet a further alternative feed regime may involve about 50% of the wastewater to be treated being fed into the reaction vessel in a first feed step, and about 50% in a second feed step.

If the wastewater to be treated carries a lower nutrient load, such as domestic wastewater, about 90% of the wastewater to be treated may be fed into the reaction vessel in a first feed step, and about 10% in a second feed step. Alternatively, about 80% of the wastewater to be treated may be fed into the reaction vessel in a first feed step, and about 20% in a second feed step. A further alternative feed regime may involve about 70% of the wastewater to be treated being fed into the reaction vessel in a first feed step, and about 30% in a second feed step. A further alternative feed regime may involve about 60% of the wastewater to be treated being fed into the reaction vessel in a first feed step, and about 40% in a second feed step. Yet a further alternative feed regime may involve about 50% of the wastewater to be treated being fed into the reaction vessel in a first feed step, and about 50% in a second feed step.

Alternatively, if a three-feed process is adopted, and wastewater carrying high levels of nutrients, such as abbatoir wastewater, is treated, 50% of the wastewater to be treated may be fed into the reaction vessel in a first feed step, about 30% in a second feed step, and about 20% in a third feed step. A further alternative feed regime may involve about 60% of the wastewater to be treated being fed into the reaction vessel in a first feed step, about 20% in a second feed step, and about 20% in a third feed step. A further alternative feed regime may involve about 60% of the wastewater to be treated being fed into the reaction vessel in a first feed step, about 30% in a second feed step, and about 10% in a third feed step. A further alternative feed regime may involve about 70% of the wastewater to be treated being fed into the reaction vessel in a first feed step, about 20% in a second feed step, and about 10% in a third feed step. A further alternative feed regime may involve about 50% of the wastewater to be treated being fed into the reaction vessel in a first feed step, about 40% in a second feed step, and about 10% in a third feed step. A further alternative feed regime may involve about 40% of the wastewater to be treated being fed into the reaction vessel in a first feed step, about 30% in a second feed step, and about 30% in a third feed step. Yet a further alternative feed regime may involve about 40% of the wastewater to be treated being fed into the reaction vessel in a first feed step, about 40% in a second feed step, and about 20% in a third feed step.

Although the wastewater may be introduced into the reaction vessel in any appropriate manner, feeding using the UniFED™ process, as described in international patent publication WO 95/24361, or an adaptation thereof may be used. Briefly, the sludge in reaction vessel 10 may be allowed to settle before at least a first feeding step, and feeding may comprise distributing the wastewater into the bottom of the reaction vessel, into the settled sludge, without aeration or stirring. This allows for intensive contacting of all biomass with the fresh feed stream entering the reactor, avoidance of mixing of the biomass with supernatant water from a previous process cycle, which often contains nitrates which can be detrimental to the performance of the phosphorous removal processes, and quickly established anaerobic conditions favourable to VFA uptake by PAOs.

The feeding step may be followed by a non-mixed, non-aerated period or, if the feeding step (which is non-mixed, non-aerated) is carried out slowly, a subsequent non-mixed non-aerated period might not be necessary: due to efficient contact between the wastewater and settled sludge when feed is distributed into settled sludge, if the feed rate is sufficiently slow, all NOₓ species present in the settled sludge may be denitrified, and volatile fatty acids taken up by PAOs soon after the feeding step is completed. Slower feed rates also result in less disturbance of the settled sludge, and therefore better contact of the feed with the sludge.

‘Sufficiently slow’ feed rates may comprise inflow rates into reaction vessel 10 of from about 20% to about 1% of the original, uncharged volume per hour, such as from about 15% to about 2% of the uncharged volume per hour, from, about 12% to about 4% of the uncharged volume per hour, from about 10% to about 5% of the uncharged volume per hour, about 10% of the uncharged volume per hour, about 9% of the uncharged volume per hour, about 8% of the uncharged volume per hour, about 7% of the uncharged volume per hour, about 6% of the uncharged volume per hour, or about 5% of the uncharged volume per hour, or any combination of any of the above feed rates.

After a sufficient non-mixed, non-aerated period or, if the feed step is carried at a sufficiently slow inflow rate, once the feeding step is over, the contents of reaction vessel 10 may optionally be mixed by any appropriate means, without aeration or with nitrogen-sparging. For example, mixing may be by an impeller 60 driven by, motor 70.

During or after the feeding step, the concentration of NOₓ species in the reaction vessel contents may be monitored by monitoring the oxidation/reduction potential (ORP) and/or pH of the reaction vessel contents, by using an online NOₓ sensor, or any combination thereof. ORP may also be monitored to assess uptake of volatile fatty acids from the contents of reaction vessel 10—as VFAs are taken up by organisms from the extracellular contents of reaction vessel 10, the ORP signal decreases, and as the VFAs are depleted from the extracellular contents of reaction vessel 10, the rate of decrease of the ORP signal slows and may plateau or even rise depending on the complexity of the contents of reaction vessel 10.

Oxidation/reduction potential may be assessed using an ORP meter 80 communicating by any appropriate means with an ORP probe 90 which is in contact with the contents of reaction vessel 10. ORP meter 80 may be connected by conductive lines 100 to ORP probe 90.

pH may be determined using a pH meter 110 communicating by any appropriate means with a pH probe 120 which is in contact with the contents of reaction vessel 10. pH meter 110 may be connected by conductive lines 130 to pH probe 120.

The concentration of NO (and oxygen) in the reaction vessel contents after at least the first non-aerated period needs to be sufficiently low before uptake of VFAs from the extracellular medium and intracellular accumulation of polyhydroxyalkanoates by PAOs (to provide energy for phosphate uptake during the subsequent aerobic phase) will occur. Once at least most of the VFAs have been depleted from the extracellular contents of reaction vessel 10, which may be determined by a break in declining ORP slope observed at ORP meter 80, a period of aeration may be started.

Alternatively, for example for, a SBR process operating industrially for the treatment of wastewaters (but full granulation still being established), each cycle of wastewater treatment (that is, from first feed to treated effluent discharge) may be of a substantially fixed timing, for scheduling purposes. In such a case, at least the first non-aerated period, and possibly other non-aerated or idle periods may be of fixed lengths of time, which may be of sufficient time to ensure sufficiently low NOₓ concentrations and depletion of the VFAs (based on the ongoing performance of the SBR) before commencing an aerated period. For example, for a three feed step process having a cycle time of approximately 6 hours, the first non-aerated period may be fixed at, say, about 20 minutes to about 1.5 hours duration (depending on the ongoing performance of the SBR system), such as about 20 minutes, about 25 minutes, about 30 minutes, about 35 minutes, about 40 minutes, about 45 minutes, about 50 minutes, about 55 minutes, about 60 minutes, about 65 minutes, about 70 minutes, about 75 minutes, about 80 minutes, about 85 minutes or about 90 minutes.

During an aerated period, air is pumped into reaction vessel 10 from blower 140 through aerator device 150 (such as, for example, an air diffuser), via conduit 160. Other possible aeration means/configurations, as are known in the art, such as a surface aerator (which does not require the use of a blower), may be used.

Although aeration may be uncontrolled, control of aeration may be required to avoid excessive dissolved oxygen in the contents of reaction vessel 10, which could, require a longer subsequent non-aerated period to provide sufficiently anoxic conditions for subsequent PHA storage by PAOs in the active sludge. In addition, excessive DO during, and particularly towards the end of an aerated period may promote nitrate accumulation; rather than nitrite accumulation. Removal of nitrogen using complete nitrification (to nitrate) consumes 33% more oxygen than oxidation to nitrite alone, and, overall carbon consumption for N removal via the nitritation/denitritation process is about 40% lower than for the nitrification/denitrification process. Thus significant savings on aeration and BOD can be made by promoting N removal by nitritation/denitritation rather than nitrification/denitrification.

Thus, the amount of dissolved oxygen in the contents of reaction vessel 10 may be controlled during an aerated step. In order to do so, the dissolved oxygen content of the wastewater may be monitored through a DO meter 170 communicating by any appropriate means with a DO probe 180 which is in contact with the contents of reaction vessel 10. DO-meter 170 may be connected to DO probe 180 by conductive lines 190. A flow meter 200 and/or a valve 210 may be used to monitor and/or regulate aeration, and may be positioned in line with conduit 160 to monitor and/or control the air flow respectively so as to maintain the DO level in the contents of reaction vessel 10 within desired ranges. The valve 210 may be any appropriate type of valve capable of providing the type of air flow control desired, such as an on/off valve, or a mass flow controller, and may be in communication with a suitable controlling module, such as a programmable logic controller (PLC) unit, which may also be in communication with DO meter 170. The controlling module may also be in communication with flow meter 200 for feedback control of air flow rate via valve 210. Alternatively, air flow rate may be controlled by other means, such as by appropriate control of blower 140 and monitoring of air flow by flow meter 200. In such an arrangement, DO meter 170, blower 140 and flow meter 200 may be in communication with a controlling module.

The contents of reaction vessel 10 may be mixed during the aerated step. This may be achieved by any appropriate means known in the art. For example, mixing may be achieved by the aeration itself, or as well as by an impeller 60 driven by motor 70.

The DO level in the contents of reaction vessel 10 may be maintained at any desired level during the aerated period. However, to facilitate rapid achievement of anoxic/anaerobic conditions before or during a subsequent feeding step and/or to promote nitritation/denitritation rather than nitrification/denitrification, dissolved oxygen levels may be maintained at limiting levels throughout an aerated step. Thus, according to an embodiment the DO levels in the contents of reaction vessel 10 are maintained at a level between about 5 mgO₂/L and about 0.1 mgO₂/L, such as between about 4 mgO₂/L and about 0.1 mgO₂/L, between about 4 mgO₂/L and about 0.3 mgO₂/L, between about 3 mgO₂/L and about 0.5 mgO₂/1, between about 3 mgO₂/L and about 1 mgO₂/L, between about 3 mgO₂/L and about 1.5 mgO₂/L, or between about 2 mgO₂/L and about 1.5 mgO₂/L, or in a range comprising any combination of any of the above listed upper or lower limits.

In an alternative aeration regime, the first aerated period may be followed by at least one cycle of a feed period and an aerated period during which the level of dissolved oxygen is controlled to allow for simultaneous nitrification and denitrification in the contents of said reaction vessel. This is possible as, if the dissolved oxygen level (DO) is kept low enough, anoxic zones may develop within the reaction vessel 10, such as within granules forming in the contents of reaction vessel 10, allowing for NOₓ reduction within those zones, and ammonium oxidation within oxic zones. Suitable DO levels at which this may be achieved, if suitable aeration monitoring and control is available, may be from about 1 mgO₂/L to about 0.1 mgO₂/L, about 0.8 mgO₂/L to about 0.2 mgO₂/L about 0.8 mgO₂/L to about 0.3 mgO₂/L about 0.7 mgO₂/L to about 0.3 mgO₂/L or about 0.5 mgO₂/L to about 0.3 mgO₂/L, or in a range comprising any combination of any of the above listed upper or lower limits.

The duration of an aerated period may be determined based on the average rate of change of the pH in a moving window of the mixed liquor. The pH of the contents of reaction vessel 10 typically increases quickly as soon as aeration is introduced but then decreases due to ammonium oxidation until nitritation is complete, after which the pH starts to rise again or decrease more slowly. This turning point is referred to as the ammonia valley (the point at which substantially all ammonium has been oxidised), characterised by a reduction in rate of pH decrease, possibly followed by a pH increase. Thus an aerated period may be completed when the ammonia valley for the contents of reaction vessel 10 is approached or has passed.

If aeration is allowed to continue beyond the ammonia valley, accumulation of nitrate at the expense of nitrite may occur in reaction vessel 10. Thus, if N removal by nitritation/denitritation is to be promoted rather than nitrification/denitrification, the aerated period may be ended once the ammonia valley is being approached or has just passed, and therefore may be ended when the rate of change of pH of the contents of reaction vessel 10 has reached a predetermined value. The predetermined value may be, for example, a rate of decrease of pH which is about 20% or less of the maximum rate of decrease observed earlier in the same aerated period (not having regard to any pH changes observed immediately after introduction of aeration, such as within 5-10 minutes after introduction of aeration, such as about 20% or less, about 15% or less, about 10% or less, about 0.8% or less, about 6% or less, about 4% or less, about 2% or less, or about 0% of the maximum rate of decrease observed. Alternatively, the predetermined value may be an absolute value for the rate of change of pH of the contents of reaction vessel 10, such as a rate of pH decrease of about 0.05 pH units or less per five minutes (not having regard to any pH changes observed immediately after introduction of aeration, such as within 5-10 minutes after introduction of aeration), such as a rate of pH decrease of about 0.04 pH units or less per five minutes, 0.03 pH units or less per five minutes, 0.02 pH units or less per five minutes, 0.01 pH units or less per five minutes, or 0 pH units per five minutes, but this value may differ widely for a given active sludge composition. The predetermined value may also comprise a positive rate of change of pH, such as the first sign of a positive rate of change of pH of the contents of reaction vessel 10, or soon thereafter (again, not having regard to any pH changes observed immediately after introduction of aeration, such as within 5-10 minutes after introduction of aeration).

Alternatively, or as a complementary mechanism for detection of the end-point of an aerated period, the duration of the aerated period may be determined based on the oxygen uptake rate (OUR) of the contents of reaction vessel 10—when nitrification is complete, oxygen demand by the active sludge decreases markedly—a point also known as the ‘DO elbow’. The oxygen uptake rate may be estimated by any appropriate method as is known in the art. For example, OUR may be estimated by the amount of aeration required to maintain the DO level at a given value, or within a given range of values. Alternatively, if valve 210 is an on/off valve, the OUR may be indirectly estimated by the amount of time valve 210 is in an “off” state (this time is inversely proportional to the OUR). End of nitrification may also be detected by a sudden rise in DO in the contents of reaction vessel 10, especially if constant aeration is employed using a variable throughput valve 210.

In addition, oxygen demand during oxidation of nitrite to nitrate is lower than oxygen demand during oxidation of ammonium to nitrite, and this can be detected as a drop in OUR as well. Thus, an aerated period may be stopped when the oxygen uptake rate of the contents of reaction vessel 10 drops to or below a predetermined value. The predetermined value may be, for example, an OUR which is about 80% or less of the maximum OUR observed earlier in the same aerated period (not having regard to any OUR values observed immediately after introduction of aeration, such as within 5-10 minutes after introduction of aeration, such as about 70% or less, about 65% or less, about 60% or less, about 55% or less, or about 50% or less of the maximum OUR observed. Alternatively, the predetermined value may be an absolute value for the OUR, such as about 1.5 mgO₂/min/L, about 1.2 mgO₂/min/L, about 1 mgO₂/min/L, about 0.9 mgO₂/min/L, about 0.8 mgO₂/min/L, about 0.7 mgO₂/min/L, about 0.6 mgO₂/min/L, or about 0.5 mgO₂/min per litre of the contents of reaction vessel 10, but this value may differ widely for a given active sludge composition.

As the nitritation and/or nitrification endpoint is approached, reached or passed, aeration may be stopped, and the contents of reaction vessel 10 optionally mixed without aeration or with nitrogen-sparging prior to carrying out a second step of wastewater feed into the reaction vessel 10. If nitrogen removal by the nitritation/denitritation pathway is to be promoted, aeration may be stopped once the nitritation endpoint is approached or reached.

Without wishing to be bound by theory, it is believed that by turning off aeration as soon as nitritation is complete, or nearing completion, nitrite oxidising bacteria (NOBs) are limited for nitrite, and therefore being disadvantaged compared to ammonium oxidising bacteria (AOBs). Over many cycles, this may lead to washing out of the NOB population within an active sludge, which in turn is believed will strengthen/further promote the nitritation/denitritation pathway (that is, reduce the amount of nitrate produced, and subsequent need for denitratation) from within the sludge. This in turn will return reduced aeration and COD requirements/costs, as described previously.

Second and third, and optionally further cycles of feeding, non-aerated periods and aerated periods may be carried out substantially as described above for the first feed step, although the feed may be introduced while the contents of reaction vessel 10 are being mixed.

A treatment cycle may be finished after a non-aerated/nitrogen-sparged step or, if greater nitrogen, and optionally phosphorous removal efficiencies are desired, a final aerated period may be carried out.

Once a treatment cycle is completed, the reactor contents are allowed to settle, before supernatant is decanted from reactor 10 via conduit 220, controlled by valve 230.

The settling time allowed will affect the amount of floccular sludge retained in the reactor between cycles, and can be controlled to promote retention of granular sludge in the reactor. Briefer settling times promote ‘wash-out’ of slower settling biomass, and therefore promote a shift towards granular sludge in a reactor. However, too brief a settling time may cause excessive washout of biomass from the reactor, with consequent loss of performance (which might not be recoverable), especially in the earlier phases of establishment of an aerobic granular sludge reactor. Accordingly, the settling time may be progressively reduced over treatment cycles as the reactor sludge approaches a fully granulated state.

The distinction between sludge blanket and supernatant during the settling period at the beginning of operation, when most of the biomass is floccular (50th percentile granule size not greater than 100 μm), should be apparent. At this stage, settling time may be adjusted to allow the removal of biomass in the top layer through decanting (at a rate of 300-400 mg MLSS/L in the effluent, although these numbers may be bigger or smaller depending on the biomass growth in the reactor). Settling may be controlled in a way that biomass from the top layer of the sludge blanket is removed while allowing biomass concentration in the reactor to remain stable or increasing. If biomass concentration in the reactor starts decreasing, settling time should be increased, to reduce the biomass wastage through decanting.

Every time that the volumetric exchange ratio (VER) is increased, settling time may be increased to avoid excessive biomass washout during the first cycles with higher VER, and subsequently reduced as described above.

In order to control the level of solids/sludge (including phosphorous, as well as some carbon and nitrogen accumulated in the biomass) in the SBR over a number of cycles or processes according to the invention, at least a portion of the contents of reaction vessel 10 may also be removed as waste during each cycle, or between cycles by any appropriate means, such as by pump 310 via conduit 320 to waste receiver 300.

Insufficient solids retention may result in washout/depletion of the organisms required for the treatment process. The amount of wastage during or between cycles may depend on the temperature at which the process is carried out, and may be determined so as to allow a sludge retention time (SRT) of from about 5 days to about 30 days. A lower SRT may be applicable when organisms have higher specific growth rates (shorter doubling times) due to for example a high temperature, while a longer SRT may be required when the specific growth rates of the microorganisms required have lower specific growth rates caused by, for example, a lower temperature. Under normal operating conditions (such as a temperature of about 20° C.), the SRT may be from about 10 to about 20 days, such as about 15 days.

For a given SRT, which is determined by the specific growth rates of microorganisms, the hydraulic retention time (HRT—the average time that a soluble compound remains in the reaction vessel 10) or VER may be adjusted such that the resulting sludge concentration in the reactor would have a reasonable settling rate, for example, so, as to allow decanting of treated wastewater to start after 30 min-1 hour settling. Typically, the higher the sludge concentration is, the longer the settling time required would be. For a given SRT, the sludge concentration in a reactor is determined by two factors, namely HRT and the solids and COD concentrations in the wastewater. The shorter the HRT is, the higher the sludge concentration in the reactor will be. The higher the COD and solids concentrations in the wastewater are, the higher the sludge concentration in the reactor will be. Nitrogen supports the growth of nitrifiers and therefore has some impact on the sludge concentration as well. However, nitrifiers typically represent a small percentage of the bacterial population in treatment systems receiving wastewaters containing high levels of COD and solids such as domestic and abattoir wastewaters.

For treatment of wastes with high nitrogen loads (such as from about 200 mg/L nitrogen or higher), the HRT may vary from about 12 hours to about 72 hours, such as about 12 hours, about 18 hours, about 24 hours, about 30 hours, about 36 hours, about 42 hours, about 48 hours, about 54 hours, about 60 hours, about 66 hours or about 72 hours. According to a specific embodiment, the HRT is about 42 hours or more, especially if the nitrogen levels are 250 mg/L or higher. The HRT also may need to be balanced against a target SBR cycle schedule—when using an SBR process, the HRT is directly related to the length of each cycle. Increasing the SBR cycle time will increase the HRT which means that less wastewater is treated per day.

If the SBR cycle time is kept constant, then volumetric exchange ratio (VER) becomes a more important parameter and a VER of from about 5% to about 50% (for high nitrogen wastewater) or from 5% to about 75% (for low nitrogen wastewater), as described further above, may be applied.

The treated wastewater resulting from a process as described above, especially if an aeration step is carried out before, settling, may comprise as little as about 2 mg/L total phosphorous and less than about 20 mg/L total nitrogen and, with proper tuning of the system, may produce effluent comprising less than about 1 mg/L total phosphorous and less than about 10-15 mg/L total nitrogen, which would meet most Australian standards for discharge into waterways. Total phosphorous in effluent obtained from such processes of the present invention may be expected to even be lower than about 0.8 mgP/L, such as less than about 0.6 mg/L, less than about 0.5 mg/L, less than about 0.4 mg/L, less than about 0.3 mg/L, or less than about 0.2 mg/L. Total nitrogen in effluent obtained from processes of the present invention may be expected to even be lower than about 10 mgN/L, such as less than about 9 mg/L, less than about 8 mg/L, less than about 7 mg/L, less than about 6 mg/L, or less than about 5 mg/L.

In contrast to waterway discharge, although disposal of wastewaters by land irrigation requires a high level of biological oxygen demand (BOD) removal (>95%), only medium levels of nitrogen and phosphorus removal are required. The presence of total phosphorus at a level of up to about 10-20 mgP/L and total nitrogen, preferably mostly in the form of ammonium, at up to about 50-100 mgN/L in the treated effluent is considered appropriate for this purpose. To meet these objectives, a process according to the invention may produce effluent with some presence of nitrogen (primarily ammonia nitrogen) and phosphorus. Such a process may be effectively similar to that described above, although only two feed steps are required, and an aerated period after the second non-aerated period is only optional, as phosphorous removal is not as important. If total nitrogen in the process effluent is to be predominantly ammonium, any aeration after the second feed step may be kept to a minimum, although a brief aeration step may be desirable to strip the effluent of any nitrogen gas formed by denitrification, and thereby improve the settling properties of the sludge in reaction vessel 10. The treated wastewater resulting from such a process will typically comprise up to about 20 mgP/L and total nitrogen at up to about 100 mgN/L, such as less than about 50 mg/L total nitrogen and less than about 15 mg/L total phosphorous. Total phosphorous in effluent obtained from such a process may be between about 10 mgP/L and about 15 mgP/L, although values below 10 mgP/L may occur. For example, total phosphorous in the resulting effluent may be less than about 12 mgP/L, such as less than about 10 mg/L, less than about 8 mg/L, less than about 7 mg/L, less than about 6 mg/L, or less than about 5 mg/L. Total nitrogen in effluent obtained from such a process may be expected to be between about 20 mgN/L and about 50 mgN/L, although values below 25 mgP/L may occur. For example, total nitrogen in the resulting effluent may be less than about 40 mg/L, less than about 35 mg/L, less than about 30 mg/L, less than about 25 mg/L, or less than about 20 mg/L.

### BOD Supplementation

Another problem that faces treatment of wastewaters high in nitrogen is lack of BOD, and particularly volatile fatty acids (VFAs) in the wastewater to be treated. PAOs require VFAs during an anaerobic period to store polyhydroxyalkanoates to provide energy for phosphate uptake during an aerobic period. Although raw abattoir wastewater has a high BOD due to elevated levels of fats oils and grease (FOG), these wastewaters are typically pre-treated to improve the settling properties of these wastes, resulting in significant depletion of biologically available carbon sources. As a result there are often insufficient carbon resources in the pre-treated wastewater for efficient or complete phosphorous uptake by PAOs or denitritation and/or denitrification by denitrifiers.

To address this, a process according to the invention may comprise supplementation of the wastewater to be treated, or being treated with a source of COD, such as VFAs (which are most readily used by PAOs for intracellular PHA storage, especially acetate and propionate) when the wastewater to be treated does not contain a sufficient amount of these for biological phosphorus and nitrogen removal.

For wastewaters comprising from about 200-300 mg/L total nitrogen, if necessary, the wastewater being fed into reaction vessel 10 may be supplemented with extra COD, or a source of COD may also be added to reaction vessel 10, to provide a total influent COD (CODt) concentration of from about 1,000 mg/L to about 3,000 mg/L. This value will also depend on whether the process is using nitrification and denitrification predominantly via nitrate, or via the nitritation/denitritation pathway, which uses approximately 40% less carbon sources. In addition, if the PAOs utilised are capable of denitrification as well as phosphate accumulation (as appears to be the case for, for example, Candidatus Accumulibacter phosphatis), further COD economies may be achieved.

The ratio of CODt to total influent nitrogen may be from about 5 to about 15, such as from about 5 to about 12, from about 5 to about 10, from about 6 to about 10, from about 7 to about 10, from about 8 to about 10, from about 5 to about 9, from about 5 to about 8, or from about 5 to about 7, or any, or any range comprising any combination of any of the above listed ratios.

For phosphorous removal from wastewater, VFAs are important, being a preferred substrate for intracellular storage of PHAs by PAOs. For wastewaters comprising from about 30-50 mg/L total phosphorous, if necessary, the wastewater being fed into reaction vessel 10 may be supplemented with extra VFAs, or a source of VFAs may also be added to reaction vessel 10, to provide a total influent VFA concentration of from about 300 mg/L to about 1,000 mg/L, such as from about 350 mg/L to about 900 mg/L VFAs, from about 350 mg/L to about 800 mg/L VFAs, from about 350 mg/L to about 700 mg/L VFAs, from about 400 mg/L to about 650 mg/L VFAs, from about 400 mg/L to about 600 mg/L VFAs, from about 450 mg/L to about 600 mg/L VFAs, from about 450 mg/L to about 550 mg/L VFAs, about 250 mg/L VFAs, about 300 mg/L VFAs, about 350 mg/L VFAs, about 400 mg/L VFAs, about 450 mg/L VFAs, about 500 mg/L VFAs, about 550 mg/L VFAs, about 600 mg/L VFAs, about 650 mg/L VFAs, or about 700 mg/L VFAs, or any, or any range comprising any combination of any of the above listed concentrations. VFAs typically make up the majority, but not all of soluble COD, and therefore, if considering soluble COD levels instead of VFA concentrations, the amount of soluble COD will be to be fed in an SBR process of the invention will be commensurately higher than the values provided above for VFAs.

The ratio of total influent VFAs to total influent phosphorous may be from about 5 to about 30, such as from about 10 to about 25, from about 12 to about 25, from about 13 to about 20, from about 14 to about 18, from about 14 to about 17, from about 14 to about 16, about 14, about 15, about 16, about 17, about 18, about 19 or about 20, or any, or any range comprising any combination of any of the above listed ratios.

A convenient source of VFAs may comprise pre-fermented raw wastewater.

Although the additional source(s) of COD/VFAs may be added to reaction vessel 10 in any appropriate manner and at any appropriate time, for ease of operation and timing of the various steps/periods during the process, including feeding steps, non-aerated periods and aerated periods, the additional COD/VFAs may be co-fed into reaction vessel 10, or may be added to the wastewater to be treated before feeding into reaction vessel 10.

Having reference to FIG. 1, raw wastewater with a high BOD (such as raw abattoir wastewater, with a high FOG level) may be pre-fermented and then held in a reservoir 240. The pre-fermented raw wastewater reservoir 240 may be linked to wastewater conduit 50 via conduit 260 and co-fed into reaction vessel 10 by pump 250 with the wastewater during a feed step. VFAs may be further supplemented during a process of the invention, if necessary, by pumping VFAs into reaction vessel 10 from a VFA reservoir 270 via conduit 290 by pump 280, independently of wastewater feeding.

The source(s) of volatile fatty acids may comprise elevated levels of acetic and propionic acids, such as at least 100 mg/L of each of acetic and propionic acids, and may be co-fed into said reaction vessel with said wastewater at the desired ratio to provide the desired CODt: total nitrogen ration and VFA: total phosphorous ratio. For example, where a pre-fermented raw abattoir wastewater is used to supplement the CODt/VFA of anaerobic abattoir pond wastewater (which is, typically low in CDOt and VFAs), the ratio of pre-fermented waste to abattoir pond wastewater may be from about 1:20 to about 1:1, such as about 1:15, about 1:10, about 1:8, about 1:7, about 1:6, about 1:5, about 1:4, about 1:3, about 1:2 or about 1:1, or any, or any range comprising any combination of any of the above listed ratios.

Excess use of pre-fermented high FOG waste should be avoided due to the possibility of impaired settling ability of the resulting sludge.

### Other Process Parameters

### a) Organisms

Granules and sludges for use in establishing aerobic granular sludge reactors by processes according to the present invention comprise an active biomass including nitrifying and denitrifying microorganisms, and optionally polyphosphate accumulating organisms (PAOs).

### i) Nitrifying and Denitrifying Organisms

Many nitrifying, nitriting, denitrifying and denitriting organisms are known in the art, and are typically present in wastewaters naturally. Any suitable combination of such microorganisms which will provide at least nitritation and denitritation in a process according to the invention may be used. Such microorganisms may be obtained from purified/isolated cultures, or may be part of a consortium of organisms enriched from naturally occurring sources, such as wastes.

A non-exhaustive list of nitrifying and denitrifying microorganisms considered to be useful for the purposes of the invention includes:

Nitriting organisms (ammonia oxidisers)

### Nitrosomonas spp.

### Nitrosococcus spp.

### Nitrosospira spp.

### Nitrosolobus spp.

Nitrifying organisms (nitrite oxidisers)

### Nitrobacter spp.

### Nitrospina spp.

### Nitrococcus spp.

### Nitrospira spp.

Denitrifying organisms (nitrate and nitrite reducers): a wide range of facultative anaerobes, including:

### Achromobacter spp.

### Alcaligenes spp.

Comomonas denitrificans

### Eschericia spp.

Micrococcus denitrificans
Pseudomonas spp. (such as P. aeruginosa)
Paracoccus spp. (such as P. denitrificans)

### Serratia spp.

Thiobacillus spp. (such as T. denitrificans)

### ii) PAOs

Polyphosphate accumulating organisms which may be of use in processes according to the invention may be any appropriate known PAO, or combination of PAOs. The PAO(s) may be obtained from purified/isolated cultures, or may be part of a consortium of organisms enriched from naturally occurring sources, such as wastes.

A non-exhaustive list of PAOs considered to be useful for the purposes of the invention includes Actinobacteria and the Rhodocyclus group of organisms, including Candidatus Accumulibacter phosphatis. The latter bacterium has also been shown to be capable of denitrification, and may be beneficial in further reducing carbon requirements in processes of the invention.

### b) Temperature (See Components 350, 360 and 370 in FIG. 1)

The operating temperature for processes of the invention is not crucial, but may be kept below 40° C., as many of the bacteria important to the process may perish at such temperatures. The temperature may also be maintained above at least 5° C. For practical process turnover times, the temperature at which the process is carried out may be at least 10° C., such as at least 15° C., at least 18° C., at least 20° C., at least 22° C. at least 24° C., at least 26° C., at least 28° C., at least 30° C., about 20° C., about 22° C., about 24° C., about 25, about 26° C., about 28° C., or about 30° C.

The temperature of the contents of reaction vessel 10 may be monitored at temperature meter 350, communicating with temperature probe 350 by any appropriate means, such as conductive line 360. If necessary, reaction vessel 10 and its contents may be heated or cooled by any appropriate means known in the art.

### c) pH Control

The optimum pH for Nitrosomonas and Nitrobacter is between 7.5 and 8.5 and nitrification by these organisms has been reported to stop at a pH at or below 6.0. However, there has also been a recent report of nitrification at pH 4.0. pH of the contents of reaction vessel 10 may be monitored as described previously. Although in most cases the pH of the reaction vessel contents will self-regulate to within pH values at which the biological processes necessary for processes of the present invention will take place, if necessary the pH of the reaction vessel contents may be adjusted by any appropriate means. For example, an alkaline agent, such as a carbonate or bicarbonate salt, or even a hydroxide, such as sodium hydroxide may be added to the reaction vessel contents to raise the pH if necessary, or an acid such as hydrochloric or sulphuric acids may be added to the reaction vessel contents to reduce pH. Such additions may be controlled automatically by a controlling module, such as a PLC, in communication with pH meter 110 and a pump controlling flow of acid or alkali from suitable reservoirs.

Preferred forms of the present invention will now be described, by way of example only, with reference to the following examples, which are not to be taken to be limiting to the scope or spirit of the invention in any way.

### EXAMPLES

### Example 1

### Materials and Methods

### Sludge Sources

Aerobic granules used as seeding in this study were sampled from a lab-scale sequencing batch reactor (SBR) treating abattoir wastewater. The wastewater has average chemical oxygen demand (COD), nitrogen (N), and phosphorus (P) concentrations of 366, 234 and 32 mg/L respectively. The reactor was operated under alternating anaerobic-aerobic conditions. The reactor had a cycle time of 8 h, with 3 L of abattoir wastewater fed at the beginning of the 1 h anaerobic period, reaching a total working volume of 5 L, giving rise to a hydraulic retention time of 13.3 h. Removal efficiencies for soluble COD, soluble N and soluble P of 85%, 93%, and 89% were achieved at the time of sampling. The granules were withdrawn at the end of the cycle and manually fragmented before mixing with the floccular biomass.

Floccular sludge used for seeding in this study was obtained from a full-scale wastewater treatment plant (WWTP) performing biological COD, nitrogen and phosphorus removal (EBPR) from domestic wastewater in Queensland, Australia.

### Preparation of the Seeding Sludge

The aerobic granules used as a seeding sludge were manually fragmented. These granules were pressed through a certified sieve with a porous size of 500 μm in diameter in order to reduce their size and obtain more fragments from fewer granules. The 10^{th} percentile of this fragmented granular mixture was 162 μm, the 50^{th} percentile was 528 μm and the 90^{th} percentile was 1042 μm. Six different combinations of fragmented granules and floccular sludge (weight/weight) were formed as follows:
SBR 0%: no fragmented granules were added. Seeding sludge was 100% floccular.
SBR 5%: 5% of the biomass (in dry weight) was fragmented granules and 95% of the biomass in weight was floccular sludge.
SBR 10%: 10% of the biomass (in weight) was fragmented granules and 90% of the biomass in weight was floccular sludge.
SBR 15%: 15% of the biomass (in weight) was fragmented granules and 85% of the biomass in weight was floccular sludge.
SBR 25%: 25% of the biomass (in weight) was fragmented granules and 75% of the biomass in weight was floccular sludge.
SBR 50%: 50% of the biomass (in weight) was fragmented granules and 50% of the biomass in weight was floccular sludge.

### Reactor Operation

Six sequencing batch reactors (SBRs) were used in this study. Each reactor had a working volume of 2 L and all reactors were operated in a temperature-controlled room (20-23° C.). The SBRs had a diameter of 7 cm and a height of 76 cm, and their mixing was carried out via a combination of a magnetic stirring (200 rpm) and intermittent sparging of either nitrogen gas (10 sec on, 15 sec off during anaerobic/anoxic periods) or air (DO 1.5-2.0 mg/L, at 1 L/min during aerobic period). The reactors were seeded with a combination of fragmented granules and floccular sludge, each having a different ratio of fragmented granules to floccular sludge. The wastewater loading per cycle was gradually increased from 0.25 L-0.5 L at the beginning of reactor operation up to 1 L later on, towards a fully granulated sludge state, thereby increasing the volumetric exchange ratio (VER) from 12.5-25% up to 50%. At the same time, settling time was progressively reduced to remove poorly settling biomass from the reactor. The SBRs had an 8 h cycle and their configuration is detailed in Table 1. The pH in the systems, which was recorded but not controlled, typically fluctuated between 6.8-8.6 over the cycle.

Cycle times were adjusted in each reactor depending on the treatment capabilities of each system, on the wastewater loading and on the sludge settling velocity. The total reaction period (all phases in the cycle except settling, idle and decant) in all the SBRs was kept the same. Settling time was adjusted depending on the settleability of the sludge and adjustment of idle time was used to unify the length of all the cycles.

TABLE 1
SBR cycle phases.

| Cycle Phase | Characteristics |
|---|---|
| Feed-1 | Bottom feed, no mixing, no aeration |
| Anaerobic-1 | Mixing, nitrogen sparging |
| Aerobic-1 | Mixing, air sparging |
| Anoxic-1 | Mixing, nitrogen sparging |
| Feed-2 | Mixing, nitrogen sparging |
| Anaerobic-2 | Mixing, nitrogen sparging |
| Aerobic-2 | Mixing, air sparging |
| Anoxic-2 | Mixing, nitrogen sparging |
| Settle | No mixing, no gas sparging |
| Decant | No mixing, no gas sparging |
| Idle | No mixing, no gas sparging |

### Abattoir Wastewater

The wastewater used in this study was from a local abattoir in Queensland, Australia. At this site, the raw effluent passes through four parallel anaerobic ponds before being treated in a SBR for biological COD and N removal. Anaerobic pond effluent from the abattoir was collected on a weekly basis and stored at 4° C. The characteristics of the anaerobic pond effluent are detailed in Table 2. Additional acetate had to be supplemented to the anaerobic pond effluent described in Table 2 as the amount of easy biodegradable COD (i.e. volatile fatty acids or VFAs) available in this particular anaerobic pond effluent was very low.

TABLE 2
Characteristics of the anaerobic pond effluent
and modified wastewater used in this study.

| | Pond | Pond | Modified |
|---|---|---|---|
| Parameters | Average | Stdev. | Average |
| CODₜₒₜₐₗ (mg/L) | 365.7 | 132.6 | — |
| COD_{soluble} (mg/L) | 147.4 | 99.7 | — |
| VFA (mg/L) | 30.0 | 27.5 | 650-900 |
| TN (mg/L) | 241.1 | 32.0 | — |
| TP (mg/L) | 36.2 | 3.5 | — |
| N—NH₄ (mg/L) | 234.1 | 24.7 | — |
| N—NOx (mg/L) | 0 | 0 | — |
| P—PO₄ (mg/L) | 32.4 | 3.7 | — |

### Analyses

Ammonia (NH₄⁺), nitrate (NO₃⁻), nitrite (NO₂⁻) and orthophosphate (PO₄³⁻—P) concentrations were analysed using a Lachat QuikChem8000 Flow Injection Analyser (Lachat Instrument, Milwaukee). Total and soluble chemical oxygen demand (CODT and CODS, respectively), total Kjeldahl nitrogen (TKN), total phosphorus, mixed liquor suspended solids (MLSS) and volatile MLSS (MLVSS) were analysed according to standard methods (APHA, (1995). Standard methods for the examination of water and wastewater, Washington, D.C., American Public Health Association). VFAs were measured by Perkin-Elmer gas chromatography with column DB-FFAP 15 m×0.53 mm×1.0 μm (length×ID×film) at 140° C., while the injector and FID detector were operated at 220° C. and 250° C., respectively. High purity helium was used as carrier gas it a flow rate of 17 mL/min. 0.9 mL of the filtered sample was transferred into a GC vial to which 0.1 mL of formic acid was added.

To determine the size distribution of particles in each SBR, 30 mL of well mixed liquor were pumped through a Malvern laser light scattering instrument, Mastersizer 2000 series (Malvern Instruments, Worcestershire, UK). The technique of laser diffraction is based on the principle that particles passing through a laser beam will scatter light at an angle that is directly related to their size. This method represents a rapid and robust measurement of particles present in a bulk with a range of 0.02 to 2000 μm.

Granule morphology was qualitatively observed using a stereomicroscope (Olympus SZH10).

### Example 2

### Preliminary Study

### Development of Aerobic Granules from Floccular Sludge with Abattoir Wastewater

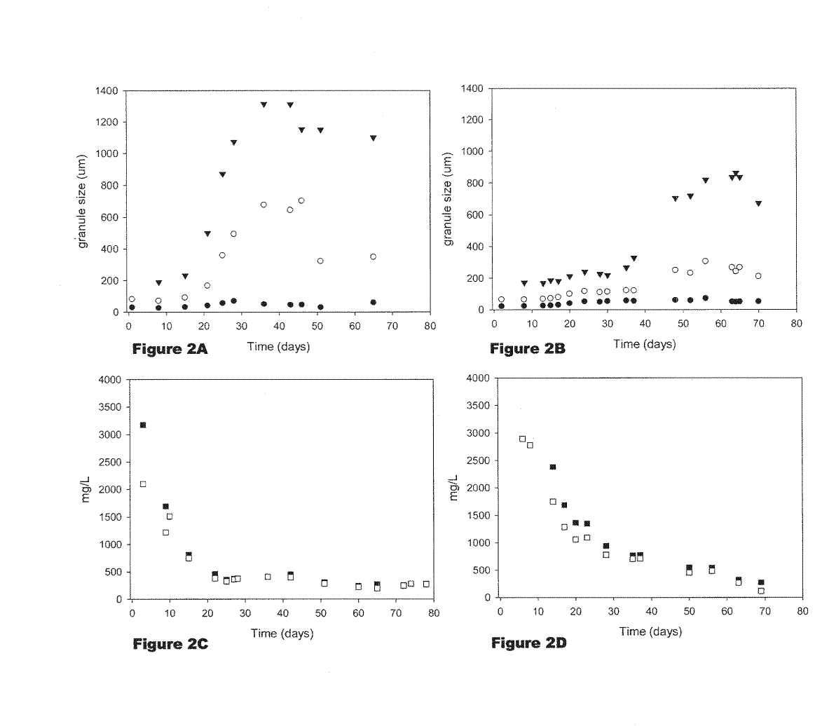

Two different start-ups were carried out seeding the SBR with floccular sludge. The strategy applied to get aerobic granules was the progressive reduction of the settling time in order to select for fast settling microorganisms. However, during the application of this strategy, a reduction of biomass in the reactor occurred in both rounds (FIGS. 2C and 2D). An increase in particle sizes was only observed when biomass concentration decreased from 3 g MLSS/L to levels lower than 1 g MLSS/L (FIGS. 2A and 2B). Although the 90^{th} and the 50^{th} percentiles were increasing, suggesting an increase of the size of the granules present, the biomass concentration never recovered.

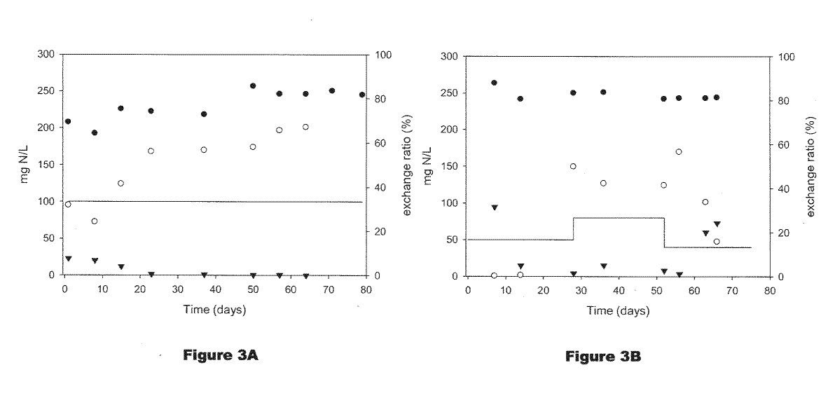

Biodegradable COD removal was achieved in both runs with an efficiency of 99% even when low levels of biomass were present. During the first run (FIG. 3A), the volumetric exchange ratio (VER) was set to 33% and was kept constant. However, nitrogen removal deteriorated due to decrease of biomass in the SBR, which caused accumulation of NH₄⁺ in the reactor, inhibiting the bacteria present. The system could not be recovered and was stopped after 80 days of operation. During run 2 (FIG. 3B) the initial VER applied in the SBR was 17% in order to avoid NH₄⁺ accumulation in the reactor. During the first 25 days, 90% N removal was achieved. The wastewater loading was slightly increased, increasing the VER to 25%. However, the system could not cope with this increase, partially because the biomass concentration was also decreasing, and N removal decreased. Although VER was reduced again, the performance did not Substantially improve and biomass concentration reached very low levels. This run was stopped after 70 days of operation.

### Challenges on the Start-Up of Aerobic Granular Reactors for the Treatment of Nutrient Rich Wastewater

Two major drawbacks were identified when an aerobic granular reactor was started with floccular sludge for the treatment of nutrient rich wastewater. The first one was the substantial reduction in biomass before granules started to develop. Granules appeared when biomass concentration was lower than 1 g MLSS/L. The second drawback, which is a consequence of the reduction in biomass, is deterioration of the nutrient removal capability of the reactor. When dealing with nutrient-rich wastewaters, this provides a risk of accumulation of nutrients in the reactor. An increase of NH₄⁺ to certain concentrations can have an inhibitory effect on the group of bacteria involved in the removal of this nutrient, the nitrifiers. Two of the major causes of inhibition of these bacteria are the elevated ammonium (or free ammonia) and nitrite (or free nitrous acid) concentrations. Therefore, biological nitrogen removal should be maintained in the start up process of an aerobic granular SBR in order to avoid inhibition to the biomass.

### Example 3

### New Seeding Strategy

### Fragmented Granules and Floccular Sludge Mixture

In order to overcome the problems associated with generating granular sludge in reactors starting from floccular sludge, a different start-up strategy was applied, using a mixture of fragmented granules and floccular sludge. Five different combinations were used in five different SBRs and results were compared.

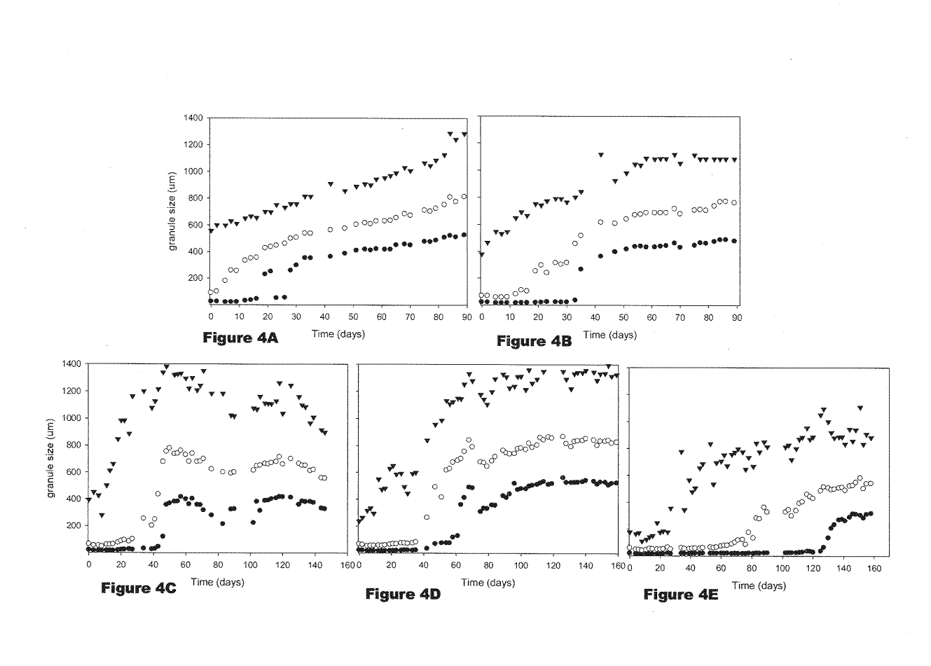

FIG. 4 shows the size distribution profiles of the 5 reactors over time from initial set-up of the reactors. The 90^{th} percentile was always substantially higher than the 50^{th} and 10^{th} percentiles due to the presence of these fragmented granules. For comparison purposes, complete granulation was deemed to be achieved when the 10^{th} percentile granule size was higher than 200 μm, the minimum size for a particle to be considered a granule.

In all cases, the 90^{th} percentile range granules increased in diameter from the beginning of operation. After a period of time (depending on each reactor) the 50^{th} percentile granules started to increase in size. Finally the 10^{th} percentile granules increased to sizes greater than 200 μm in, diameter, indicating that all the biomass in the reactor was in the form of granules.

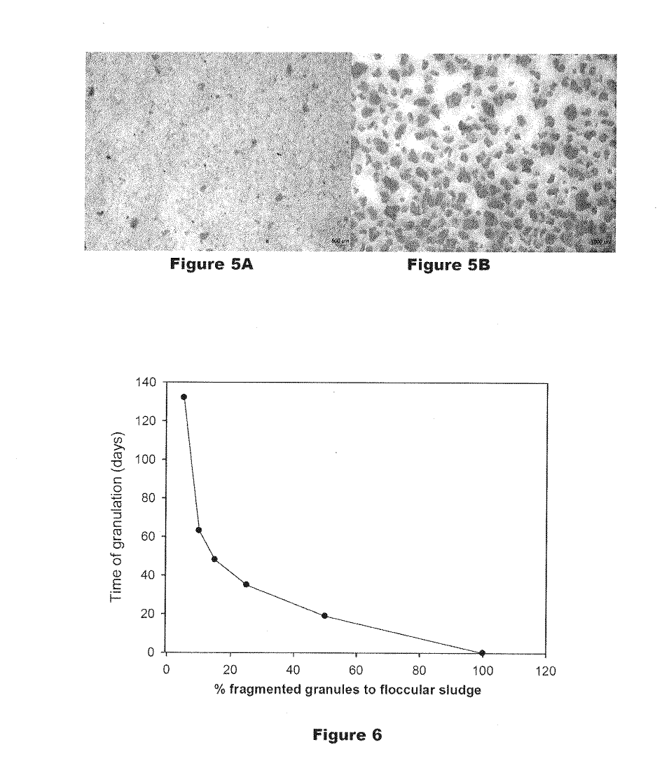

Stereomicroscope pictures of the sludge present in each of the 5 SBRs were taken each week. As an example, FIG. 5A shows the appearance of the sludge when the 10% fragmented granular SBR was started and FIG. 5B shows the appearance of the sludge from the last week of operation. A clear transition to a predominantly granular sludge is apparent.

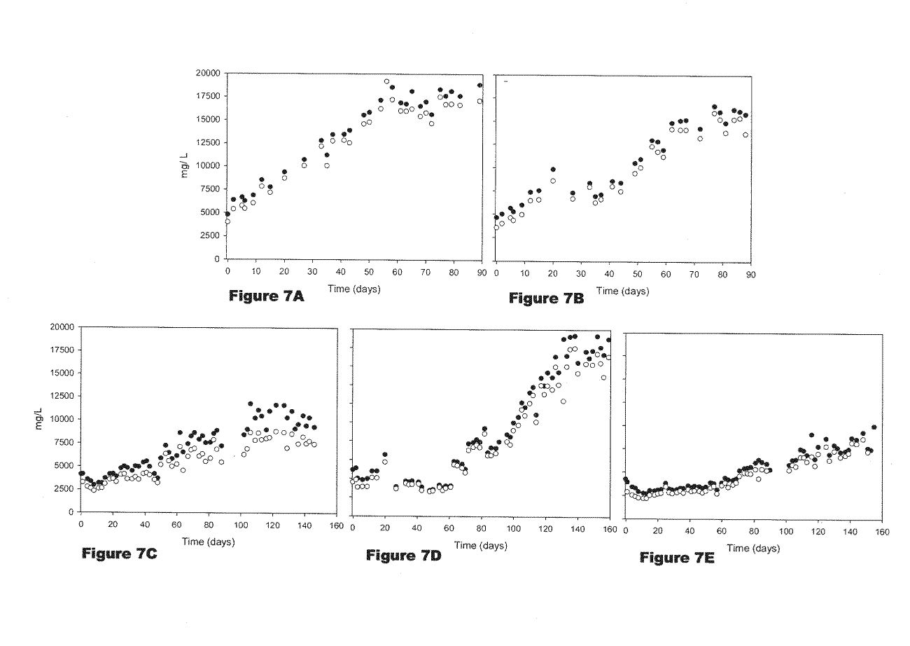

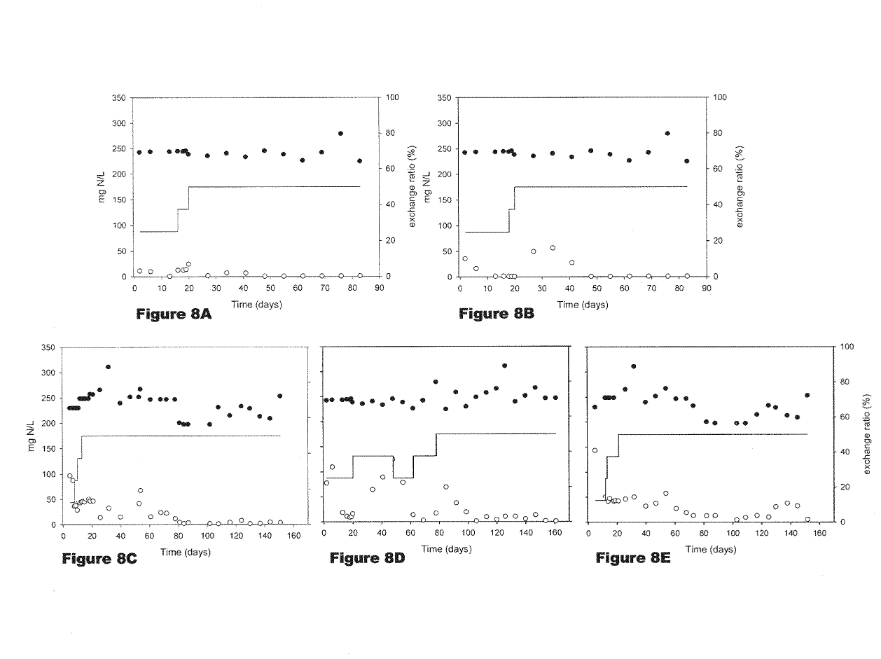

The shortest time for complete granulation to be achieved occurred in the SBR seeded with 50% fragmented granules and 50% floccular sludge (FIG. 4A) while the longest occurred in the SBR seeded with 5% fragmented granules and 95% floccular sludge (FIG. 4E). FIG. 6 shows the correlation between the percentage of fragmented granules present in the seeding sludge and the time of granulation.

As expected, the more fragmented granules initially present in the reactor, the faster was the system to become fully granulated. However, starting a reactor with a higher percentage of aerobic granules is not a realistic scenario. First, there are few wastewater treatment plants operated with aerobic granules worldwide, and these are only in the start-up phase. Secondly, the cost of aerobic granular sludge and its transport from one plant to start another one could be important. These facts make the usage of a sludge combination with a lower percentage of fragmented granules a more attractive approach.

As described in Example 2, our previous attempts to achieve aerobic granular sludge from abattoir wastewater using 100% floccular sludge always resulted in a substantial loss of biomass in the process of getting a fully granular system. The reactor could not cope with the high levels of ammonia that the abattoir wastewater contains inhibiting the microbial activity and ultimately causing failure of the reactor. However, using a combination of fragmented granules and floccular sludge seems to avoid or minimize the decrease of biomass in the reactors. FIG. 7 shows biomass concentration along the operational period in all the SBRs.

### Example 4

### Nutrient Removal

In order to optimize the amount of carbon needed for the nutrient removal process, simultaneous nitrification, denitrification and phosphorus removal (SNDPR) was promoted in the reactors. Also, the nitrite pathway (ammonia oxidation to nitrite) was encouraged since this provides oxygen savings during the nitrification step, and carbon savings during denitrification compared to conventional nitrogen removal treatment. Relatively low DO was applied in the reactors (1.5-2.0 mg O₂/L) to create anoxic zones in the aerobic period that helps simultaneous nitrification and denitrification, and the aeration was stopped when ammonia was depleted.

FIG. 8 shows the nitrogen present in the wastewater and in the effluent of the five SBRs. High nitrogen removal efficiency was achieved in all the reactors during most of the operational period. A slight decrease in nitrogen removal was observed in some reactors during the first days after increasing the VER but it was rapidly restored.

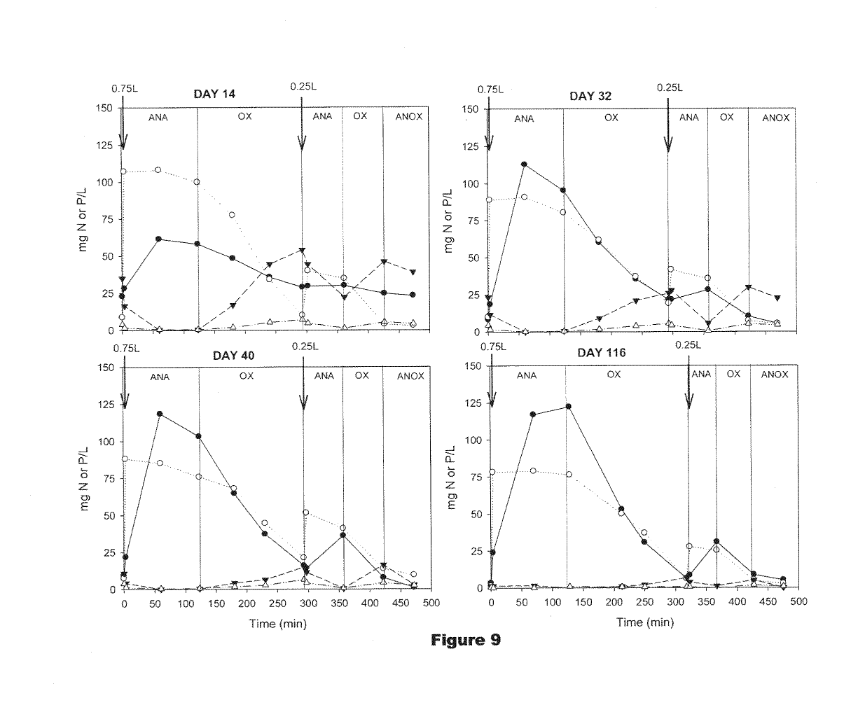

FIG. 9 shows 4 cycle study profiles measured along the operational period in the SBR seeded with 15% fragmented granules as an example of how simultaneous nitrification and denitrification was achieved.

Results obtained after 14 days of reactor operation (FIG. 9—‘Day 14’)) show that nitrite was the final product of nitrification, and although some SND was observed, most of the nitrite produced accumulated during nitrification. While an EBPR phenotype was detected, hardly any net P removal was obtained, probably due to inhibition of P uptake by nitrite. The second anaerobic period appears to have acted as an anoxic period when full SND had not yet been established, and carbon supplied by the second feed appears to have been, used to reduce some of the nitrite present at the end of the first aeration. Around 30 mg N—NO₂⁻/L were remaining at the end of the cycle and was carried on to the subsequent anaerobic phase, allowing denitrifiers to compete with EBPR microorganisms for substrate.

By day 32 (see FIG. 9—‘Day 32’)), SND was better, and less nitrite accumulated in the first aerobic period, and EBPR was also improving.

On day 40 (FIG. 9—‘Day 40’), most of the biomass present in the SBR was granulated, which, promotes simultaneous existence of aerobic and anoxic conditions. SND was the major nitrogen removal process in the reactor, and just 10 mg N—NO₂⁻ accumulated towards the end of the first aerobic phase. EBPR was excellent, achieving more than 95% P removal.

The cycle study performed on day 116 (FIG. 9—‘Day 116’) represents the stable operation of this reactor. Full SNDPR was achieved and very low levels of N and P were found in the effluent.

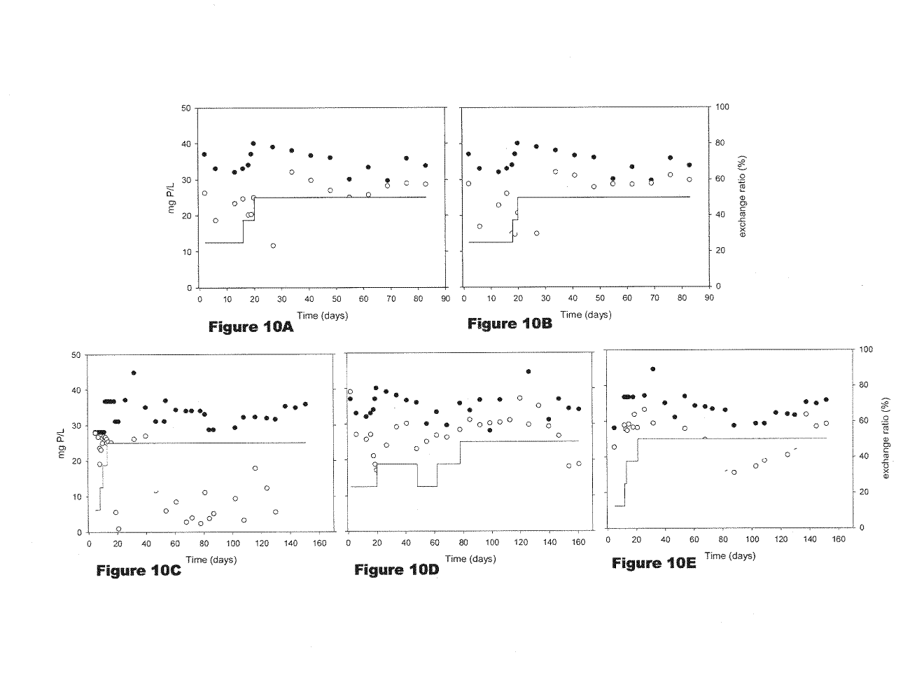

All the SBRs started with a VER between 12.5 and 25%. Having a higher VER has been suggested to promote faster granulation because more supernatant can be discharged in one cycle, and more of the slower settling biomass is washed out from the reactor. However, with a nutrient-rich wastewater, the increase in VER has to be done taking into account the nutrient removal capability of the reactor, to avoid accumulation of nutrients and subsequent inhibition. The increase in wastewater loading was carried out progressively in all reactors, making sure that nitrogen removal was not compromised. If accumulation occurred, the VER was decreased again (see, for example, FIG. 10D) until nutrient removal recovered.

While increasing the VER, HRT was gradually reduced to 16 h in all the SBRs (treating IL of wastewater each cycle). 100% BOD removal and higher than 90% N removal were achieved for most of the operational period, including the transition period to fully granular systems.

On the other hand, significant and stable biological phosphorus removal was only achieved in the SBR seeded with 15% fragmented granules (FIG. 10C). Biological phosphorus removal is a very complex process and can be difficult to achieve. Nowadays, P removal continues to be achieved primarily through chemical precipitation, despite biological P removal being a much cheaper and more environmentally sustainable option. When treating abattoir wastewater, biological removal of P becomes especially challenging. The wastewater contains a high level of ammonia and organic nitrogen, and the complete nitrification of these nitrogenous components produces a high level of nitrate, which has proved to be an obstacle to the development of a stable and reliable Bio-P removal process. Phosphorus removal requires alternating anaerobic and aerobidanoxic conditions, but the high level of nitrate (due to the high influent nitrogen concentrations) makes the creation of anaerobic conditions in the system difficult.

Another reason behind EBPR, failure can be the proliferation of a group of microorganisms called Glycogen Accumulating Organisms (GAOs) that compete for carbon source with Polyphosphate Accumulating Organisms (PAOs) responsible for the biological P removal. During the first weeks of operation nitrite was present in relatively high concentrations during the aerobic phases (see FIG. 9, days 14 and 32 as examples). Nitrite has been reported to strongly inhibit P-uptake by PAOs and this could be one of the reasons that GAOs could overcome PAOs in most of the SBRs. However, this is an issue for EBPR in general rather than just related to this technology.

### Example 5

### Effect of the Size of Seeding Granules on Reactor Start-Up Time

The effect of the size of granules used for seeding sludge at start-up time was investigated. Two SBRs were inoculated with 30% granular sludge combined with 70% floccular sludge (on a weight basis). The only difference between the reactors was size distribution of the granules used with floccular sludge to form the seeding sludge. Table 3 shows the size distribution of the granules used as a seeding for each SBR before combining them with the floccular sludge. It has to be taken into account that the combination between floccular and granular sludge was done on a weight basis, and therefore, the two reactors had correspondingly different numbers of aerobic granules, the reactor with the larger granules having fewer granules.

TABLE 3
10^{th}, 50^{th} and 90^{th} volumetric percentiles
of the granules used in the three SBRs.

| | 10^{th} percentile | 50^{th} percentile | 90^{th} percentile |
|---|---|---|---|
| | (μm) | (μm) | (μm) |
| m-SBR | 440.77 | 727.26 | 1184.3 |
| (medium particles) | | | |
| b-SBR | 923.16 | 1268.26 | 1645.76 |
| (big particles) | | | |

The granules used in the “medium particles SBR” or m-SBR were withdrawn from a reactor treating abattoir wastewater without fragmenting them. The granules used in the “big particles SBR” or b-SBR were withdrawn from another aerobic granular SBR treating the same abattoir wastewater with bigger granules. These granules were also used untouched (no fragmentation was applied).

FIG. 11 shows the appearance of the sludge present in the two SBRs just after inoculation.

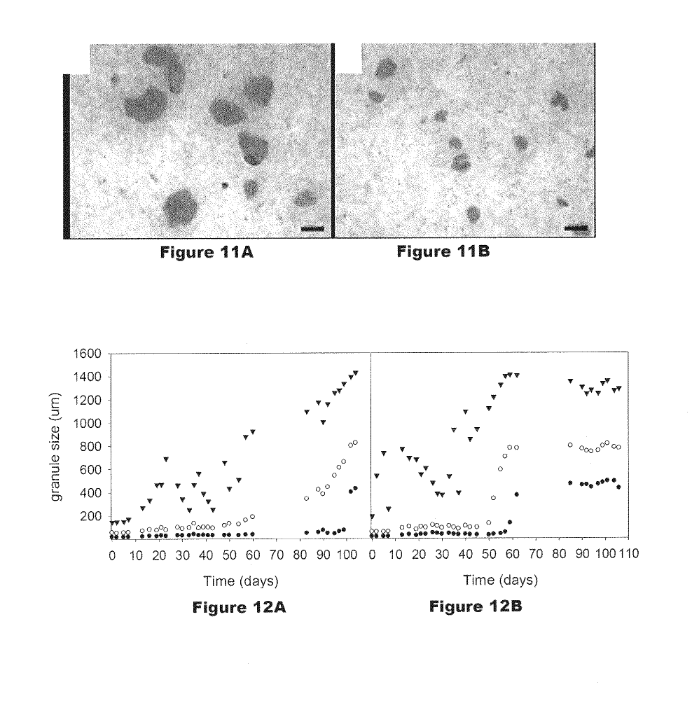

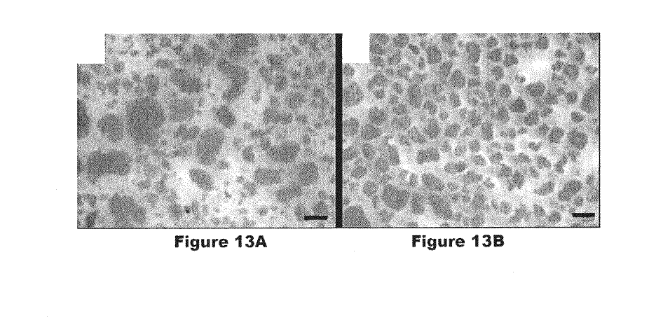

FIG. 12 shows the size distribution profiles of the two SBRs (b-SBR—FIG. 12A and m-SBR—FIG. 12B) during their operation over more than 100 days.

Full granulation was obtained in the m-SBR after 60 days of operation. On the other hand, the SBR inoculated with a combination comprising larger granules achieved full granulation after 100 days of operation. This indicates that having smaller, but more granules in the starting sludge could significantly reduce the granulation process and therefore establishment of an aerobic granular sludge reactor.

FIG. 13 shows the appearance of the biomass on day 92 of operation. The biomass concentration in both reactors increased during the start-up period and nutrient removal was achieved in both reactors in a similar way as reported previously.

### CONCLUSIONS

Using a mixture of fragmented aerobic granules and floccular sludge has been shown to reduce the start-up time for aerobic granular sludge reactors for the treatment of nutrient-rich wastewater.
There is a positive correlation between the amount of fragmented granules used and the time for achieving complete granulation.
99% COD removal and 90% nitrogen removal were achieved during the operational period in all the reactors, even during the transition period. EBPR can also be achieved.
Using fragmented granules in the seeding sludge reduces the start-up time for an aerobic granular sludge reactor.

It will be appreciated that, although a specific embodiment of the invention has been described herein for the purpose of illustration, various modifications may be made without deviating from the spirit and scope of the invention as defined in the following claims.

1. A process for establishing an aerobic granular sludge reactor, said process comprising seeding a reactor with an active biomass comprising fragmented aerobic sludge granules, wherein the fragmented aerobic sludge granules retain at least a structural feature of aerobic sludge granules and substantially retain the functionality of the aerobic sludge granules, and wherein the fragmented aerobic sludge granules are not floccular sludge.

2. A process according to claim 1, wherein said fragmented aerobic sludge granules have a median particle size of from about 150 μm to about 1250 μm.

3. A process according to claim 1, wherein the active biomass further comprises floccular sludge.

4. A process according to claim 1, wherein the fragmented aerobic sludge granules are about 5% to about 50% of the total active biomass by weight.

5. A process according to claim 4, wherein the fragmented aerobic sludge granules are about 10% to about 25% of the total active biomass by weight.

6. A process according to claim 1, wherein the initial concentration of active biomass in the reactor is from about 1 gMLSS/L to about 5 gMLSS/L.

7. A process according to claim 26, wherein said reactor is initially run with a wastewater loading providing a volumetric exchange ratio per treatment cycle of from about 12.5% to about 25%.

8. A process according to claim 26, wherein said reactor is eventually run with a wastewater loading providing a volumetric exchange ratio per treatment cycle of up to about 50%.

9. A process according to claim 26, wherein the process comprises a settling time between completion of a treatment cycle and a supernatant and wherein the settling time is gradually reduced over the number of treatment cycles run during establishment of the aerobic granular sludge reactor.

10. A process according to claim 1, wherein said active biomass comprises nitrifying and denitrifying organisms for removal of biological COD and nitrogen from a wastewater.

11. A process according to claim 10, wherein the wastewater for treatment comprises at least 100 mg/L nitrogen.

12. A process according to claim 10, wherein a source of volatile fatty acids is fed into said reactor as well as wastewater.

13. A process according to claim 12, wherein said source of volatile fatty acids is fed into said reactor or added to said wastewater in an amount such that the overall soluble COD per litre of an influent to said reactor is from about 500 mg COD/L to about 600 mg COD/L.

14. A process according to claim 12, wherein said source of volatile fatty acids is fed into said reactor or added to said wastewater in an amount such that the overall ratio of total COD to total nitrogen in an influent to said reactor is from about 5 to about 10.

15. (canceled)

16. A process according to claim 11, wherein said active biomass comprises polyphosphate accumulating organisms (PAOs) for simultaneous removal of nitrogen, phosphate and biological COD from wastewater.

17. A process according to claim 16, wherein a wastewater for treatment comprises phosphorus and wherein a source of volatile fatty acids is fed into said reactor or added to said wastewater in an amount such that the overall ratio of total COD to phosphorous in an influent to said reactor is about 15.

18. A process according to claim 1, wherein the process further comprises at least a first wastewater feeding step comprising distributing a wastewater for treatment into a settled sludge at the bottom of said reactor.

19. A process according to claim 18, wherein the contents of the reactor are not mixed during at least a portion of said at least first wastewater feeding step.

20. A process according to claim 18, wherein the contents of the reactor are not mixed during at least a portion of a non-aerated period following said at least first wastewater feeding step.

21. A process according to claim 26, wherein each wastewater treatment cycle comprises two wastewater feeding steps, and wherein each wastewater feeding step is followed by a sequence comprising an anaerobic step, an aerobic step and then an anoxic step.

22. A process according to claim 1, wherein the fragmented aerobic sludge granules have a median particle size of from about 500 μm to about 700 μm.

23. Fragmented aerobic sludge granules for use in the process according to claim 1, wherein the fragmented aerobic sludge granules have a median particle size of from about 150 μm to about 700 μm, wherein the fragmented aerobic sludge granules retain at least a structural feature of aerobic sludge granules and substantially retain the functionality of the aerobic sludge granules, and wherein the fragmented aerobic sludge granules are not floccular sludge.

24. The fragmented aerobic sludge granules according to claim 23, wherein the fragmented aerobic sludge granules have a median particle size of from about 500 μm to about 700 μm.

25. A process according to claim 1, the process further comprises, prior to the seeding step, a step of fragmenting aerobic sludge granules to produce the fragmented aerobic sludge granules.

26. A process according to claim 1, wherein the process further comprises one or more cycles of wastewater treatment.

27. A process according to claim 1, wherein the fragmented aerobic sludge granules are prepared by fragmenting aerobic sludge granules using a fragmentation means, which allows for retaining at least a structural feature and substantial functionality of aerobic sludge granules.
